(19) United States
(12) Patent Application Publication
(10) Pub. No.: US 2009/0238670 A1
(43) Pub. Date: Sep. 24, 2009

(54) ROBOT GRIPPER FOR FOOD PRODUCTS

(75) Inventors: Hjalmarsson Helgi, Kopavogur (IS); Bjorn Jonsson Einaar, Reykjavik (IS)

Correspondence Address: BROOKS KUSHMAN P.C., 1000 TOWN CENTER, TWENTY-SECOND FLOOR, SOUTHFIELD, MI, 48075, US

(73) Assignee: VALKA EHF, Kopavogur (IS)

(21) Appl. No.: 12/302,979

(22) PCT Filed: May 31, 2007
(86) PCT No.: PCT/IS07/00013

§ 371 Date: Dec. 4, 2008

(30) Foreign Application Priority Data
May 31, 2006 (IS) 8494

(51) Int. Cl. B65G 47/90; B25J 15/08; B25J 19/04; B25J 9/00; G06F 7/00; G06F 19/00; B66C 1/10

(52) U.S. Cl. 414/685; 294/101; 414/816; 700/213

(57) ABSTRACT

The invention relates to a gripper for a robotic arm which is specially designed for fresh food products. The invention also relates to a method, a device and a system which arranges food products fully automatically onto a conveyor, e.g. in-feed conveyor to an IQF freezer, or into a tray or a box. The gripper unit comprises penetration mechanism for penetrating into the articles that are to be picked up, thereby providing an engagement between the gripper unit and the articles while rearranging the positions of the articles, whereby the position of the penetration mechanism into the articles is operated in such a way that one end of the articles becomes at least partially freely hanging.

### FIELD OF THE INVENTION

The present invention relates to a gripper unit for a movable end of a computer controlled robotic arm and a robotic device, where the gripper unit being arranged to pick-up articles, typically fresh food products, for flipping over or relocating or straightening out the articles, or the combination thereof. The present invention further relates to a use of a gripper arm in a combination with a robot arm for flipping over or relocating or straightening out the articles, or the combination thereof. The present invention further relates to a method performed in a robotic device of picking-up articles, typically fresh food products, for flipping over or relocating or straightening out the articles, or the combination thereof. The present invention further relates to a system for picking-up articles, typically fresh food products, for flipping over or relocating or straightening out the articles, or the combination thereof.

### BACKGROUND OF THE INVENTION

Various types of grippers have been used in the food industry in the past.

WO 2005/051812 discloses a gripper for securing to a movable end of a computer controlled robotic arm by which articles can be picked up, optionally rotated and lowered into a new position. The tooling comprised two blades each having a leading edge and trailing edge, movable between a first position in which their leading edge are separated by a large gap and a second position in which the leading edges overlap, or are in contact or are separated by a smaller gap. In an alternative embodiment the tooling may include a vacuum chuck or two or more spikes each of which positively engages in the article, and rotation of the article is achieved by rotating the vacuum chuck or a member from, which the spikes depend, in a plane which is generally parallel to the plane containing the two blades.

The disadvantage with this invention is that it only allows in-plane displacement of the articles, but not straightening them out or turning the articles around, which in some applications is of a great importance, e.g. in the fish industry where it is preferred to let the skin of a fish fillet turn down when packing the fillets into trays/boxes or feeding the fillets into a freezer. In some packaging applications, where multiple layers of fish are placed in a tray or a box, to let the skin sides of the fillets be in contact as more bacterias are typically on that side. Furthermore, the embodiment including the vacuum gripper has the disadvantage that when the articles are soft food product they can easily be damage. Also, the vacuum drags moisture out of the product which reduces the weight of the product and thus the yield. Furthermore, the equipment needed for vacuum suction is expensive and makes loud noise which is a disadvantage as food producers want to continuously improve the working environment for their workers.

WO 93/16849 discloses a gripper unit for a manipulator robot which is fitted with at least two gripper fingers mounted on a gripper, where the gripper fingers are controlled move relative to each other, the gripper fingers being fitted with holding elements that include pins. The objects are accordingly locked in a fixed place between the pins under the action of the holding force exerted by the gripper.

Clearly, such a gripper unit would not be suitable in food industry, especially when processing fresh food products such as fish fillets or chicken fillets, since be exerting with two opposite forces onto the objects would easily damage the objects. Furthermore, the degrees of freedom of this gripper unit are very limited and do not allow turning the articles around.

Other grippers that are available are commonly some sort of shovels which need to be sufficiently big for the biggest piece which are to be picked up. Those gripper become too big for smaller pieces and will thus reduce the throughput which otherwise could be obtained. These grippers need furthermore that the pieces are properly placed on a conveyor before they can pick them up and can not ensure that they are properly aligned when they are put down again.

### BRIEF DESCRIPTION OF THE INVENTION

The objective of the current invention is to solve the above mentioned problem by providing a simple gripper unit which when implemented with a robotic device that is capable of not only displace articles, such as fish fillets, in a two dimensional plane, but also is capable of turning the articles around and straightening them out.

According to one aspect, the present invention relates to a gripper unit for a movable end of a computer controlled robotic arm, the gripper unit being arranged to pick-up articles, typically fresh food products, for flipping over or relocating or straightening out the articles, or the combination thereof, comprising:
a penetration means for penetrating into the articles that are to be picked-up, thereby providing an engagement between the gripper unit and the articles while rearranging the positions of the articles, whereby the position of the penetration means into the articles is operated in such a way that one end of the articles becomes at least partly freely hanging.

Thereby, the articles picked up in such a way that it provides a large degree of freedom of rearranging the position of the articles. As already mentioned, this may include turning the articles around so that the desired side of the article facing upwards, a linear displacement e.g. from one conveyor to the next or within the same conveyor, a rotation displacement or a combination thereof. The extra degree of freedom relating to turning the articles around is of particular advantage in many industrial applications such as the fish industry, where it is typically required that the skin of the fish fillets is facing down prior to e.g. packing the fillets into trays, or prior entering into freezer. Also, by picking up the articles in the way as disclosed here the articles which are wrinkled or lie on top of each other may be flatten out.

In an embodiment, the penetration means comprises curved shaped needles. In that way, it is ensured that the articles will not be damaged in any way when penetrating into the articles.

In an embodiment, the gripper unit further comprises a supporting mechanism for supporting the articles during the penetration of the penetration means, the supporting mechanisms comprising means for exerting with a force opposite to the penetration means during the penetration into the articles. This is to ensure that the needles will penetrate through the articles when they are picked up, since in some cases the weight of the articles as an example compared to their stiffness is not sufficient to ensure that the penetration means of the gripper unit can penetrate through the article when it is lifted up.

In an embodiment, the gripper unit further comprises a releasing mechanism for releasing the articles from the penetration means, the releasing mechanism comprising means for exerting with a force onto the articles until they are removed from the penetration means. Thereby, it is ensured that the articles, that otherwise might be difficult to drag of the penetrations means, will be removed therefrom.

According to another aspect, the present invention relates to a use of a gripper arm in a combination with a robot arm for flipping over or relocating or straightening out the articles, or the combination thereof.

According to still another aspect, the present invention relates to a robotic device for picking-up articles, typically fresh food products, for flipping over or relocating or straightening out the articles, or the combination thereof, wherein a detection mechanism associated to the device is used for providing at least one operation parameter for each respective article indicating the initial position of the articles and based thereon which articles need to be re-placed, the device comprising:
a gripper unit arranged to be mounted to a movable end of a computer controlled robotic arm of the robotic device, the gripper unit comprising a penetration means for penetrating into those articles where a re-placement is needed, thereby providing an engagement between the gripper unit and the articles while rearranging the positions of the articles, whereby the position of the penetration into the articles is such that one end of the articles becomes at least partly freely hanging, and
a control unit for operating the gripper unit based on the operation parameters.

In an embodiment, the at least one operation parameter is selected from a group consisting of:
an position related parameter indicating the position of the articles,
an orientation related parameter indicating the initial orientation of the articles,
an overlap related parameter indicating whether the one or more articles overlap each other,
a wrinkle related parameter indicating whether the articles are wrinkled or not,
an ups-and-downs related parameter indicating which side of the articles is facing up and which side is facing down.

In an embodiment, the position of the penetration means into the articles is at the periphery of the articles. In that way, it is ensured that one end of the articles that are picked up will be freely hanging, thereby e.g. simplifying the turning over process, or the rotation/displacement of the articles.

In an embodiment, the ups-and-downs related parameter is determined from a light intensity of an image taking of the surface of the articles, or by emitting light onto the surface of the articles and detect the light reflected from the surface.

In an embodiment, the robotic arm has at least two degrees of freedom and the gripper unit at least one degree of freedom, and wherein the operation is based on operating each individual degree of freedom in an independent way.

In an embodiment, the articles are on a conveyor wither stationary or while being conveyed, or in a tray or a box.

According to yet another aspect, the present invention relates to a method performed in a robotic device of picking-up articles, typically fresh food products, for flipping over or relocating or straightening out the articles, or the combination thereof, wherein a detection mechanism associated to the device is used for providing at least one operation parameter for each respective article indicating the initial position of the articles and based thereon which articles need to be re-placed, the method comprising:
penetrating into those articles where a re-placement is needed, thereby providing an engagement between the gripper unit and the articles while rearranging the positions of the articles, whereby the position of the penetration into the articles is such that one end of the articles becomes at least partly freely hanging, and
operating the gripper unit based on the operation parameters.

In an embodiment, the flipping over or relocating or straightening out the articles, or the combination thereof, comprises picking-up articles and placing the articles onto the same conveyor, or another conveyor, or into a tray or a box.

In an embodiment, the articles are selected from a group consisting of:
fish products including fish fillets,
poultry products, and
meat products.

According to further aspect, the present invention relates to a computer program product directly loadable into the internal memory of a digital computer, comprising software code portions for performing the above method steps when the product is run on a computer.

According to further aspect, the present invention relates to a computer readable media for instructing a processing unit to perform the above method steps.

According to further aspect, the present invention relates to a system for picking-up articles, typically fresh food products, for flipping over or relocating or straightening out the articles, or the combination thereof, the system comprising:
an imaging system for capturing images of the articles,
a processing unit for processing the images and based thereon determine at least one operation parameter for each respective article, where the parameters indicate the initial position of the articles and based thereon which articles need to be re-placed,
a gripper unit arranged to be mounted to a robotic arm of the robotic device, the gripper unit comprising a penetration means for penetrating into the articles where a re-placement is needed, thereby providing an engagement between the gripper unit and the articles while rearranging the positions of the articles, whereby the position of the penetration means into the articles is such that one end of the articles becomes at least partly freely hanging, and
a control unit for operating the gripper unit based on the at least one operation parameter.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1a shows a system for aligning randomly arranged articles in regular patterns on a conveyor,

FIGS. 1b and c show in greater details how an article is picked up at the end of a conveyor,

FIG. 2a shows an alignment system for aligning randomly arranged articles in regular patterns in a box,

FIG. 2b shows in greater detail how an article is picked up from the conveyor,

FIG. 3, shows how articles which have been grabbed can be placed in front of a camera to determine which side of the article is facing a camera,

FIG. 4 shows how an article can be laid down such that the left side of the article will be facing upwards,

FIG. 5 shows how an article can be laid down such that the right side of the article will be facing upwards,

FIG. 6 shows how additional mechanism can be used on the gripper to ensure that the gripper will penetrate into the article,

FIG. 7 shows schematically how additional mechanism can be used to push the article of the needles of the gripper,

FIG. 8 shows how articles which are wrinkled and piled up can be laid flat with the alignment system,

FIG. 9 shows a robot arm with the typical degrees of freedom which are needed in the current invention,

FIG. 10 shows the degrees of freedom in the gripper unit when additional mechanism for ensuring penetration into the articles and the release of the articles is used, and

FIG. 11 shows a flow chart of a method according to the present invention performed in a robotic device of picking-up articles.

### DESCRIPTION OF EMBODIMENTS

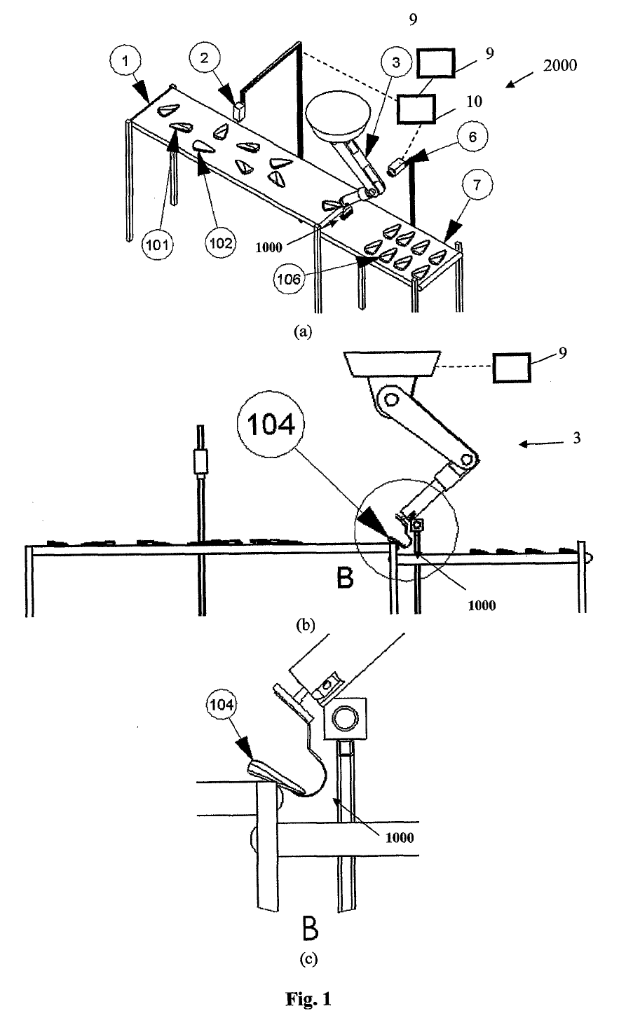

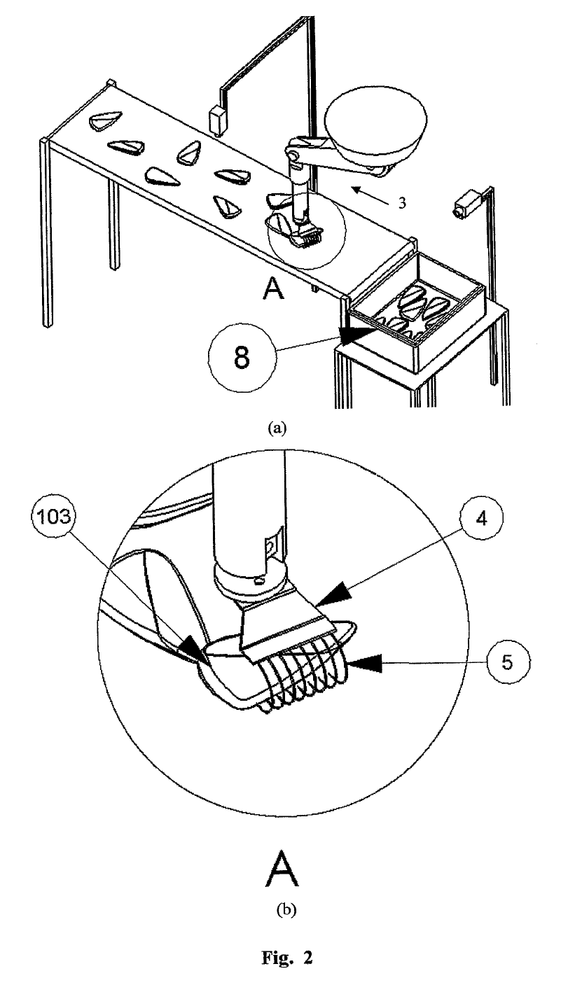

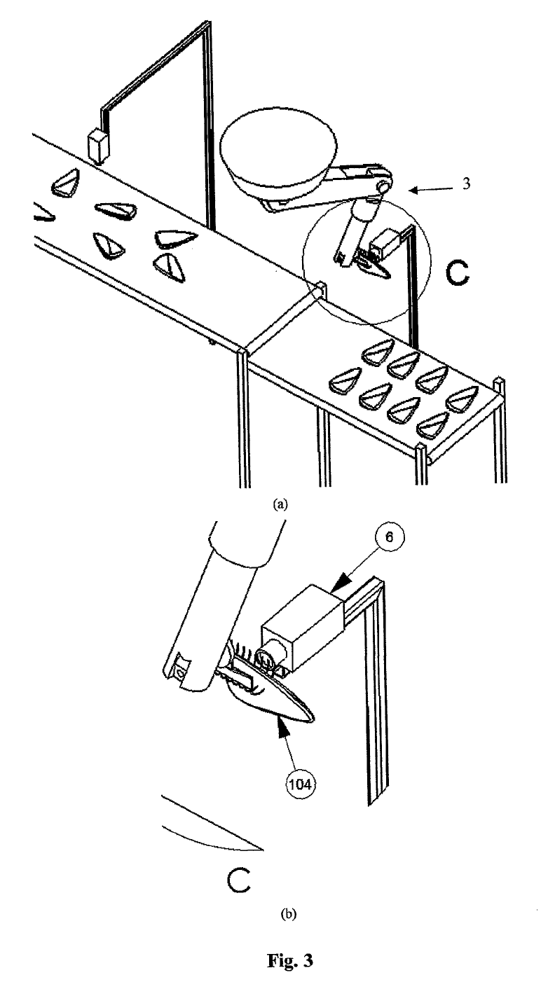

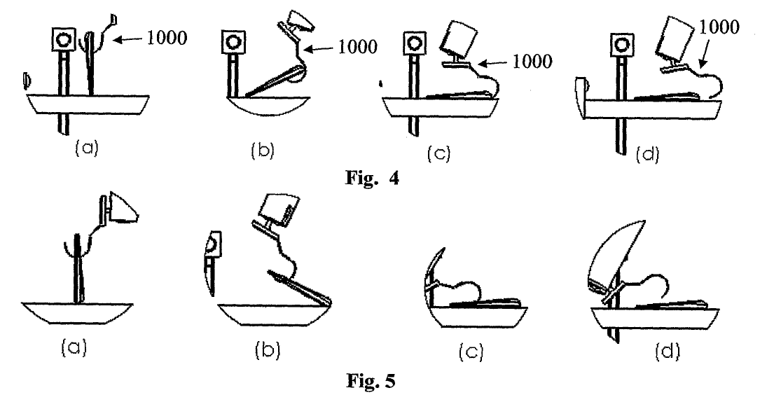

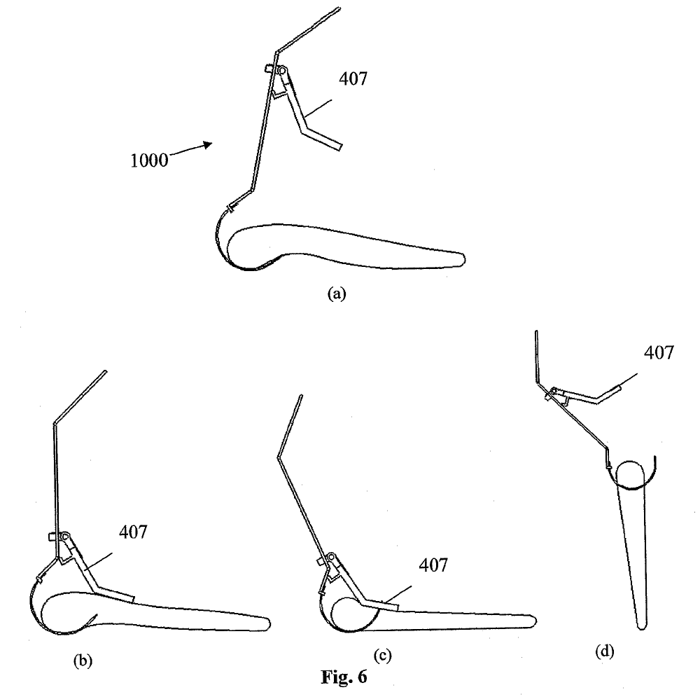

In FIG. 1 shows a system 1000 according to the present invention for picking-up articles 101, 102, typically fresh food products, where the system is arranged to flip over and/or relocate and/or straighten out the articles, or the combination thereof, where the articles may be randomly ordered. The articles which are to be aligned 101, 102 come in this embodiment on a conveyor 1. The location of the articles is recorded by a detection mechanism 2, 6 associated to the device, which in this embodiment comprises a first camera 2 which transmits the information to a control unit (not shown on drawings). Once the precise location and orientation of an article 101, 102 has been determined by the control unit 9 it is traced with an encoder (not shown on figure) or similar device on the conveyor 1. The article 101, 102 can then either be grabbed on the conveyor 1 (see FIG. 2) or when the article passes of the end of the conveyor (see FIG. 1). A robotic device 3 would typically be used to hold the gripper unit 1000 and it would typically have at least 2 degrees of freedom. In a more typical configuration the robotic device 3 has six degrees of freedom and the gripper unit can have additional degrees of freedom in some applications. The gripper unit 1000 consists of a plate 4 and a penetration means, which in an embodiment comprises a number of curved needles 5 which typically would have sharp ends such that they can easily penetrate through the articles without damaging them. The robotic device 3 will move the gripper unit 1000 such that the needles 5 will move through the article to be grabbed 103, 104. Once the article has been grabbed it is placed in front of the second camera 6 which transmits information to the control unit 9 which can determine which side of the object is facing the camera as shown in FIG. 3. This is commonly needed in the fish industry when feeding fish fillets or portion of fillets into an IQF freezer. Then it is commonly desired that the skin side of the fillet is facing downwards when the fillet enters the freezer. Having determined which side of the article is to face downwards it can be taken off the gripper unit 1000 either as shown in FIG. 4 or as is shown in FIG. 5. The pieces will then lay flat with the correct alignment and orientation either on a conveyor 7 as is shown on FIG. 1 or in a tray or a box 8 as shown in FIG. 2.

In some instances the weight of the articles compared to it's stiffness are not sufficient to ensure that the needles of the gripper unit can penetrate through the article when it is lifted up. In those cases it can be necessary to have additional mechanisms on the gripper unit to ensure that the needles will penetrate through the articles when they are picked up. One possible embodiment of such mechanism is shown in FIG. 6. The additional degrees of freedom needed for such mechanism is shown on FIG. 10.

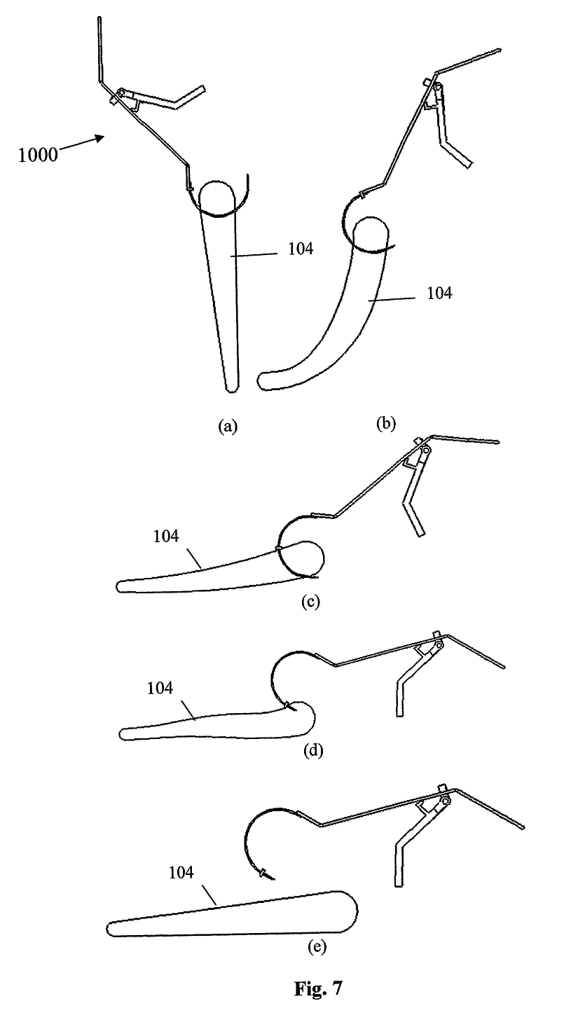

In other instances it might be difficult to drag the articles of the needles. In such cases there can be a mechanism at the end of the needles which can be pushed along the needles or the needles can be dragged through this mechanism to ensure that the articles will be removed from the gripper. One possible embodiment of such mechanism is shown in FIG. 7. The additional degrees of freedom needed for such mechanism is shown on FIG. 10.

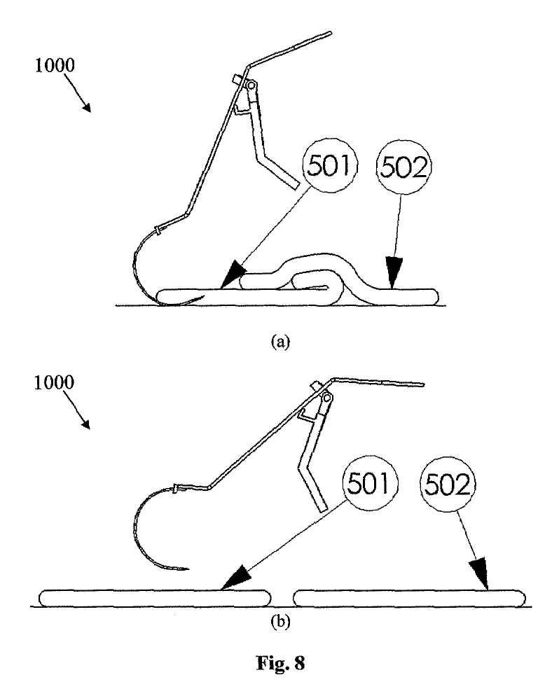

The current invention is not only concerned with aligning articles which lie perfectly flat on a conveyor. The invention will also be able to flatten out articles which are wrinkled or lie on top of each other. In FIG. 8 is shown a side view of two articles 501, 502 which are wrinkled and article 502 lies on top of article 501. It is shown how the gripper unit can grip article 501 and drag it from article 502 and lay it flat on a conveyor as desired. Afterwards article 502 is picked up and laid flat as well as shown in FIG. 8 b).

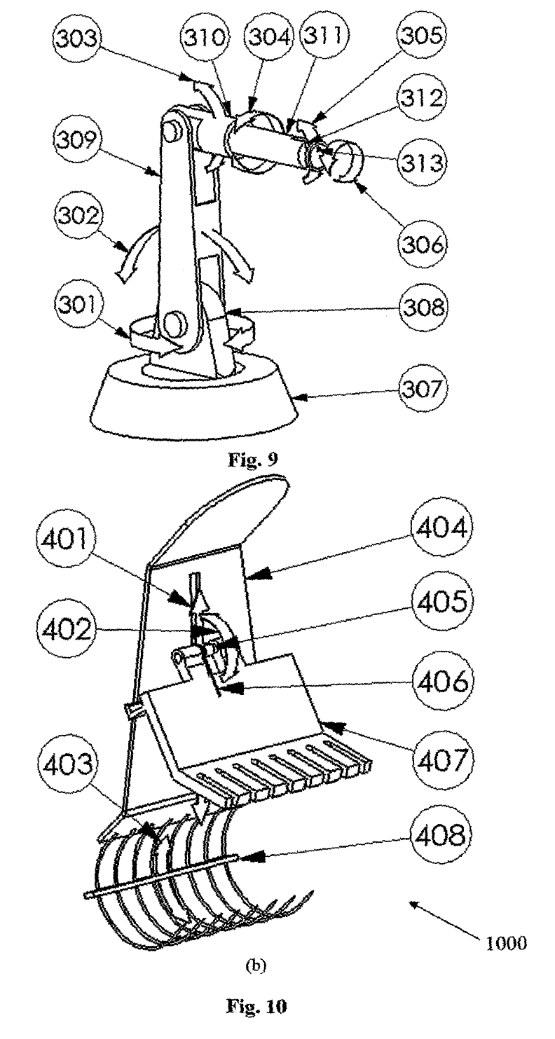

In FIG. 9 is shown a robotic device 3 with a typical set of joints which are needed in the robot which controls the gripper unit. The base unit 307 is typically attached to the floor or to the ceiling where the robotic device 3 is to be used and is thus fixed. The first link 308 is connected to the base by the base joint and can rotate around an axis as shown on FIG. 9 with arrow 301. The second link 309 is connected to the first link 308 by the shoulder joint and can rotate around an axis as shown with arrow 302. The third link 310 is connected to the second link 309 by the elbow joint which can rotate around an axis as shown with arrow 303. The fourth link 311 is connected to the third link 309 by the roll joint which can rotate around an axis as shown with arrow 304. The fifth link 312 is connected to the fourth link 311 by the pitch joint which can rotate around an axis as shown with arrow 305. The sixth link 312—also called tool flange—is connected to the fifth link 311 by the yaw joint which can rotate around an axis as shown with arrow 306.

In FIG. 10 is shown an embodiment of the gripper unit with additional mechanisms to aid in gripping the articles and to release the articles from the gripper 1000. The base plate of the gripper unit 404 is typically fixed firmly to the tool flange 313 shown in FIG. 9. The supporting mechanism for ensuring penetration of the needles into the articles consists in this embodiment of two links and it has two degrees of freedom 401, 402. The first link 405 is connected to the base plate 404 by the sliding joint and can slide as shown with arrow 401. The second link 407 is connected to the first link 405 by the rotational joint and can rotate around an axis as shown with arrow 402. Additionally there can be a torque spring 406 to ensure the proper pressure on the article to be grabbed. Furthermore, the shape of the base plate 404 can ensure that the second link 407 approaches the article to be grabbed in the right manner.

A schematic view of the mechanism to force the articles off the needles is shown in FIG. 10. A releasing mechanism which in this embodiment comprises a push-off plate 408 has one degree of freedom—that is rotational movement along the needles as shown with arrow 403. In other instances the push of plate 408 can be stationary and then the needles are dragged through the push-off plate thus ensuring that the articles will be forced of the gripper unit.

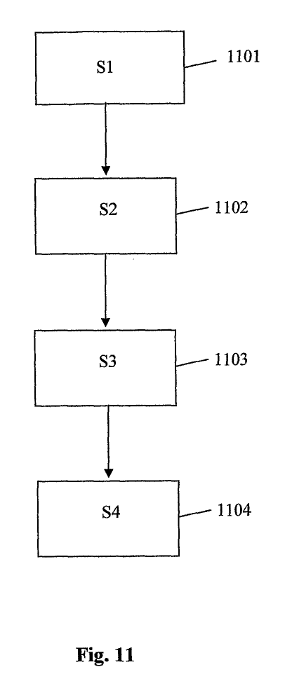

FIG. 11 shows a flow chart of a method according to the present invention performed in a robotic device of picking-up articles, typically fresh food products, for flipping over or relocating or straightening out the articles, or the combination thereof. In a first step at least one operation parameter is determined (S1) 1101, where the operation parameter is selected from a group of operation parameters consisting of: an position related parameter indicating the position of the articles, an orientation related parameter indicating the initial orientation of the articles, an overlap related parameter indicating whether the one or more articles overlap each other, a wrinkle related parameter indicating whether the articles are wrinkled or not, an ups-and-downs related parameter indicating which side of the articles is facing up and which side is facing down. Based thereon, the articles are determined that need to be relocated, or straightened, or turned around, or the combination thereof (S2) 1102. Subsequently, the articles where re-placement (turned around etc) is needed are picked-up by penetrating with a penetration means into the articles (S3) 1103 and thereby grapping them, wherein the replacement is operated based on the operation parameters (S4) 1104.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. A gripper unit for a movable end of a computer controlled robotic arm the robotic arm having at least two degrees of freedom movement and is adapted to operate the movement of the gripper unit, the gripper unit being arranged to pick-up fresh food articles, for flipping over or relocating or straightening out the fresh food articles, or the combination thereof, comprising:
a penetration means comprising a number of curve shaped needles forming a shuffle like penetration means movable in at least two degrees of freedom movement way including an angular movement allowing the curved shaped needles to shuffle up or down, wherein the gripper unit is adapted to be operated such that the angular position of the gripper unit and thus the curved shaped needles is adapted to the alignment of for the fresh food articles that are to be picked-up, such that when penetrating into the articles with the curve shaped needles thereby an engagement between the gripper unit and the fresh food articles is provided, with a subsequent shuffle up or down movement while rearranging the positions of the fresh food articles, whereby the position of the penetration means into the fresh food articles is operated in such a way that one end of the fresh food articles becomes at least partly freely hanging.

2. (canceled)

3. A gripper according to claim 1, further comprising a supporting mechanism for supporting the fresh food articles during the penetration of the penetration means, the supporting mechanisms comprising means for exerting with a force opposite to the penetration means during the penetration into the fresh food articles.

4. A gripper according to claim 1, further comprising a releasing mechanism for releasing the fresh food articles from the penetration means, the releasing mechanism comprising means for exerting with a force onto the fresh food articles until they are removed from the penetration means.

5. A use of a gripper arm according to claim 1 in a combination with a robot arm for flipping over or relocating or straightening out the fresh food articles, or the combination thereof.

6. A robotic device for picking-up fresh food articles, typically fresh food products, for flipping over or relocating or straightening out the articles, or the combination thereof, wherein a detection mechanism associated to the device is used for providing at least one operation parameter for each respective article indicating the initial position of the articles and based thereon which articles need to be re-placed, the device comprising:
a gripper unit arranged to be mounted to a movable end of a computer controlled robotic arm of the robotic device, the gripper unit comprising a penetration means for penetrating into those fresh food articles where a re-placement is needed, thereby providing an engagement between the gripper unit and the fresh food articles while rearranging the positions of the fresh food articles, whereby the position of the penetration into the fresh food articles is such that one end of the fresh food articles becomes at least partly freely hanging, and
a control unit for operating the gripper unit based on the operation parameters.

7. A robotic device according to claim 6, wherein the at least one operation parameter is selected from a group consisting of:
an position related parameter indicating the position of the fresh food articles,
an orientation related parameter indicating the initial orientation of the fresh food articles,
an overlap related parameter indicating whether the one or more fresh food articles overlap each other,
a wrinkle related parameter indicating whether the fresh food articles are wrinkled or not,
an ups-and-downs related parameter indicating which side of the fresh food articles is facing up and which side is facing down.

8. A robotic device according to claim 6, wherein the position of the penetration means into the fresh food articles is at the periphery of the fresh food articles.

9. A robotic device according to claim 7, wherein the ups-and-downs related parameter is determined from a light intensity of an image taking of the surface of the fresh food articles, or by emitting light onto the surface of the fresh food articles and detect the light reflected from the surface.

10. A robotic device according to claim 6, wherein the robotic arm has at least two degrees of freedom and the gripper unit at least one degree of freedom, and wherein the operation is based on operating each individual degree of freedom in a independent way.

11. A robotic device according to claim 5, wherein the fresh food articles are on a conveyor wither stationary or while being conveyed, or in a tray or a box.

12. A method performed in a robotic device of picking-up fresh food articles, typically fresh food products, for flipping over or relocating or straightening out the fresh food articles, or the combination thereof, wherein a detection mechanism associated to the device is used for providing at least one operation parameter for each respective article indicating the initial position of the fresh food articles and based thereon which fresh food articles need to be re-placed, the method comprising:
penetrating into those fresh food articles where a re-placement is needed, thereby providing an engagement between the gripper unit and the fresh food articles while rearranging the positions of the fresh food articles, whereby the position of the penetration into the fresh food articles is such that one end of the fresh food articles becomes at least partly freely hanging, and
operating the gripper unit based on the operation parameters.

13. A method according to claim 12, wherein the flipping over or relocating or straightening out the fresh food articles, or the combination thereof, comprises picking-up fresh food articles and placing the fresh food articles onto the same conveyor, or another conveyor, or into a tray or a box.

14. A method according to claim 12, wherein the fresh food articles are selected from a group consisting of:
fish products including fish fillets,
poultry products, and
meat products.

15. A computer program product directly loadable into the internal memory of a digital computer, comprising software code portions for performing the steps of claim 12 when the product is run on a computer.

16. A computer readable media for instructing a processing unit to perform the method steps as claimed in claim 12.

17. A system for picking-up fresh food articles, typically fresh food products, for flipping over or relocating or straightening out the fresh food articles, or the combination thereof, the system comprising:
an imaging system, for capturing images of the fresh food articles,
a processing unit for processing the images and based thereon determine at least one operation parameter for each respective article, where the parameters indicate the initial position of the fresh food articles and based thereon which fresh food articles need to be re-placed,
a gripper unit arranged to be mounted to a robotic arm of the robotic device, the gripper unit comprising a penetration means for penetrating into the fresh food articles where a re-placement is needed, thereby providing an engagement between the gripper unit and the fresh food articles while rearranging the positions of the fresh food articles, whereby the position of the penetration means into the fresh food articles is such that one end of the fresh food articles becomes at least partly freely hanging, and
a control unit for operating the gripper unit based on the at least one operation parameter.
